(19) United States
(12) Patent Application Publication
(10) Pub. No.: US 2020/0159405 A1
(43) Pub. Date: May 21, 2020

(54) CONNECTING PROCESS SYSTEM AND METHOD

(71) Applicant: VINH HUY PHAM, San Jose, CA (US)

(72) Inventor: VINH HUY PHAM, San Jose, CA (US)

(21) Appl. No.: 16/686,090

(22) Filed: Nov. 15, 2019

Related U.S. Application Data
(60) Provisional application No. 62/768,006, filed on Nov. 15, 2018.

(51) Int. Cl. G06F 3/0488; H04L 29/08; G06F 3/0481

(52) U.S. Cl. CPC G06F 3/04883; G06F 3/0481; H04L 67/306

(57) ABSTRACT

A method of connecting users and profiles, each user has a point amount and each profile has a point threshold. The method comprises comparing a user's point amount with the point threshold of a profile, presenting a user interface control associated with the profile according to a result of the comparison, detecting a gesture associated with the interface control, and creating a connection between the user and the profile in response to the gesture.

### RELATED APPLICATIONS

This application claims benefit under 35 U.S.C. § 119(e) to U.S. Provisional Application Ser. No. 62/768,006, entitled “CONNECTING USERS BASED ON AUCTIONS,” filed Nov. 15, 2018.

### TECHNICAL FIELD

This invention relates generally to computer connecting systems and more particularly to a connecting process system and method.

### BACKGROUND

Existing systems and methods for connecting users, profiles, or other things for many purposes such as housing, employment, education, medical residency, services, commerce, and dating, have failed to resolve several long-felt problems. For example, in modern dating apps run on smartphones, a first user swipes right on a second user's profile to express an interest in that second user. After the second user also swipes right on the first user, the two users are connected and allowed to chat.

One problem that has arisen is that many users swipe right indiscriminately, casting a wide net for a good catch. Users caught in that net are therefore inundated with connections to users who may not really be interested in chatting. After wasting time pursuing such connections, users become skeptical about the seriousness of the connections they receive and may not want to invest much time in pursuing each connection.

Another problem is that users cannot express whom the user would like to be connected with the most because users have no way to indicate that they prefer one target profile over another when they swipe right on both. Consequently, target users have no way to determine whether a connection is serious or instead a result of serial swiping. A target user may mistakenly ignore a serious connection, frustrating the pursuing user at the other end of that connection.

Another problem is that a user is often forced to decide whether to express an interest or to dismiss a profile as soon as the profile is presented to the user. Once dismissed, a profile is often gone for good. The user has no opportunity to decide on a profile with the benefit of comparing that profile to other profiles and evaluating the competition in pursuing that and other profiles.

Another problem is that existing dating apps often allow users to attempt or receive many new connections at once, without considering that each user has limited time and resource to seriously pursue each connection. There is no effective method to help users focus on the connections they genuinely want and should pursue.

Another problem is that after swiping right on a target's profile, a user has no way to know when or whether his profile will ever be presented to that target, and if presented, when or whether the target also swipes right on the user. Even if the target eventually swipes right back, and a connection is established, the user's connection may just be one of the many connections that a popular target receives. The user has no way to evaluate the competition he is facing to get the target's attention. He may waste time writing to the target without receiving a response because a popular target may be distracted by many connections and may ignore or delete most messages.

Another problem is that, a target user has no way to estimate how desirable a pursuing user is to other users, or how much the pursuer wants to connect to the target user more than other pursuers do, information that may be helpful to a target user in deciding whether to connect or to invest time in a connection with the pursuer.

### SUMMARY

In one embodiment, a method of displaying a user interface, comprises presenting a graphical representation of an item of information associated with a profile, the profile having a point threshold. It also comprises reading a point amount of a first user, comparing the point amount of the first user with the point threshold of the profile, and presenting a user interface control associated with the profile. In one embodiment, when it is detected that a result of said comparing allows the first user to allocate points to the profile, and that there is a first gesture associated with the user interface control, corresponding to an indication that the first user allocates points to the profile, the point allocation indication is stored in response to detecting the first gesture.

The method may further comprise detecting a second gesture associated with the user interface control, the second gesture corresponding to an indication that the first user allocates additional points to the profile and storing the additional point allocation indication in response to detecting the second gesture.

In some embodiments, when it is detected that a result of said comparing does not allow the first user to allocate points to the profile, and that there is a gesture associated with the user interface control, corresponding to the first user adding or removing the profile to or from a list of profiles, said list of profiles is updated in response to detecting the gesture.

In some embodiments, when it is detected that the profile is associated with a second user, having a second point amount, who has allocated points to the first user, the user interface control is changed in response to such detection. In some embodiments, when it is further detected that there is a gesture associated with the user interface control, the gesture corresponding to the first user creating a connection to the second user, the method further comprises storing the connection between the first user and the second user.

Presenting a user interface control may comprise changing the interface control according to the comparison of the point amount of the first user with the point threshold of the profile. The method may further comprise changing the user interface control in response to detecting a gesture on the interface control. The method may further comprise changing the point threshold or the point amount in response to the gesture.

Depending on the specific features implemented, embodiments may exhibit some, none, or all of the following technical advantages. Various embodiments may be capable of automatically connecting, for chatting with the target user, the user who is allocating the greatest number of points to the target user at a predetermined time. Some embodiments may be capable of presenting a list of all users who have allocated points to a target user to allow the target user to choose one to connect to instantly. In addition, some embodiments may provide the ability to credit a portion of the points allocated to the target user's point amount after a connection is made. Various embodiments may be capable of returning the allocated points to the point amount of a user who did not win a connection with a target user. Other technical advantages will be readily apparent to one skilled in the art from the following figures, description, and claims.

### BRIEF DESCRIPTION OF THE DRAWINGS

Reference is now made to the following description taken in conjunction with the accompanying drawings, wherein like reference numbers represent like parts.

FIG. 1A is an overview of one embodiment of the connecting system;

FIG. 1B shows one embodiment of the user interface of terminal 10 from FIG. 1A, displaying to a user the graphical representation of a profile, where the point amount of the user exceeds the point threshold of the profile;

FIG. 2 is a diagram of the display from FIG. 1B showing the effect of a gesture associated with user interface control 14, e.g., touching a button, corresponding to the user allocating points to the profile;

FIG. 3 is a diagram of the display from FIG. 2 showing the effect of a second gesture associated with user interface control 14, corresponding to the user allocating additional points to the profile;

FIG. 4 shows one embodiment of the user interface of terminal 10 from FIG. 1A, displaying to a user the graphical representation of a profile, where the point amount of the user is less than the point threshold of the profile and where the profile has not been added to a list of profiles such as a list of bookmarked profiles. It also shows the effect of a gesture associated with user interface control 14 in FIG. 5, e.g., touching a bookmark button, corresponding to the user removing the profile from the list of profiles.

FIG. 5 is a diagram of the display from FIG. 4 showing the effect of a gesture associated with user interface control 14, corresponding to the user adding the profile to the list of profiles, or where the profile has already been added to the list of profiles;

FIG. 6 shows one embodiment of the user interface of terminal 10 from FIG. 1A, displaying to a first user the graphical representation of a profile, where the profile is associated with a second user who has allocated points to the first user.

FIG. 7 is a flowchart depicting a method of displaying user interface control 14 of terminal 10 of FIGS. 1B-6 in connecting system 100 of FIG. 1A in accordance with an embodiment.

FIG. 8 illustrates an example communication interface between users of the connecting system.

### DETAILED DESCRIPTION

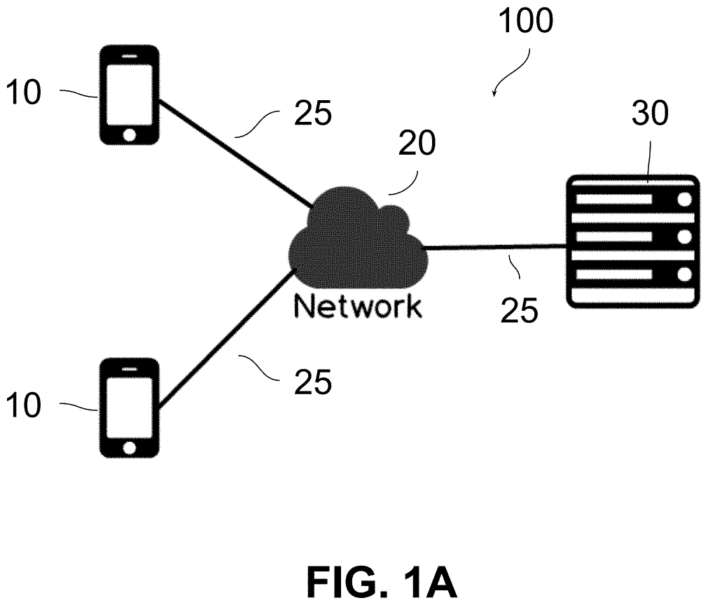

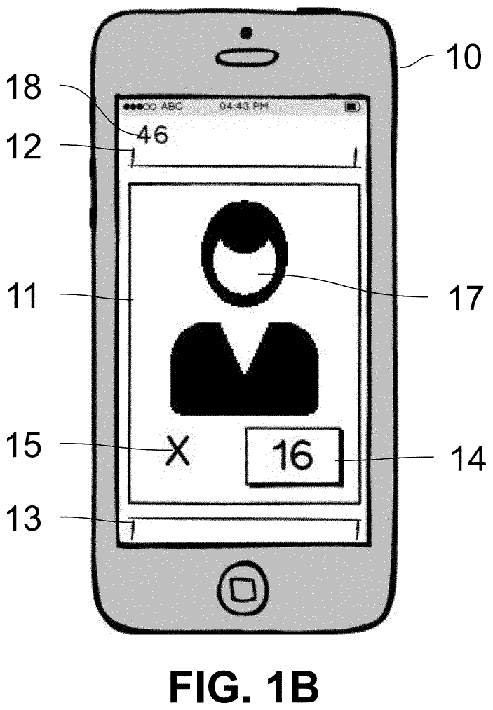

Referring to FIG. 1A, one embodiment of a connecting system is shown. FIG. 1A is a simplified block diagram of a system 100 for facilitating an on-line dating scenario in a network environment. In other embodiments, system 100 can be used to connect users, entities, or things in other areas (e.g., to connect roommates, employees with employers, students with schools, medical residents with hospitals, clients with services, customers with products, etc.). Users interact with a connecting server 30 through terminals 10.

In one embodiment, terminal 10 may be a smartphone. Alternatively, terminal 10 may be a cellular telephone, a computer, an electronic tablet, a device specifically designed for connecting users, or any other suitable communication device. The display of each device may be a touchscreen, monitor, projector, speaker, or other component to transmit information to users.

Connecting server 30 may be any computer with memory, and at least one CPU. The memory may store databases. Connecting server 30 is operable to receive and to communicate information to terminals 10. In some embodiments, connecting server 30 may comprise a plurality of servers or other equipment, each performing different or the same functions to receive and communicate information to terminals 10. Connecting server 30 may include software and/or algorithms to achieve the operations for processing, communicating, delivering, gathering, uploading, maintaining, and/or managing data, as described herein. Alternatively, such operations and techniques may be achieved by any suitable hardware, component, device, application specific integrated circuit (ASIC), additional software, field programmable gate array (FPGA), server, processor, algorithm, erasable programmable ROM (EPROM), electrically erasable programmable ROM (EEPROM), or any other suitable object that is operable to facilitate such operations. Terminals 10 and connecting server 30 are communicatively coupled via network connections 25 and network 20.

Network 20 is a communicative platform operable to exchange data or information. Network 20 could be a plain old telephone system (POTS), any packet data network, any local area network (LAN), metropolitan area network (MAN), wide area network (WAN), wireless local area network (WLAN), virtual private network (VPN), intranet, the Internet, or any other appropriate architecture or system that facilitates communications in a network or telephonic environment, including a combination of any networks or systems described above. In various embodiments, network connections 25 may include, but are not limited to, wired and/or wireless mediums which may be provisioned with routers and firewalls.

In one embodiment, users of terminals 10 view data or information associated with other users in the system. After viewing such data or information, users may seek to connect with other users to communicate with them via network 20. Data or information, as used herein, refers to any type of text, graphics, audio or video data, or any information or data in any appropriate format that may be communicated.

In some embodiments, each user using terminal 10, registers with connecting server 30. Registration may include a user submitting information to connecting server 30 about the user as well as characteristics of other users or things that the user is seeking to connect with. In various embodiments, connecting server 30 may be configured to collect this information; for example, connecting server 30 may be configured to ask each user to respond to a series of questions. Connecting server 30 may be configured to receive the information submitted by each user and create a profile for each user based on that information, storing the profile in the memory of the connecting server.

FIGS. 1B-6 depict embodiments of a user interface presented to users of the connecting system discussed above. Connecting server 30 may be configured to search through its memory to present profiles to a user using terminal 10. In FIG. 1B, one embodiment of this presentation is depicted as occurring through the screen of a smartphone, operable to detect and receive touch input such as a tap or a swiping gesture. In various embodiments, profiles may be presented to the user utilizing other communication schemes, such as electronic messages or text messages.

Using terminal 10, the user may request that connecting server 30 present profiles based on specified search parameters such as age, education, distance, etc., or based on algorithms for matching users. The list may be limited in length, e.g., 5 profiles per day, to keep the list fresh and help users focus. In the example embodiment of FIG. 1B, a result list of profiles is presented to the user in a vertically scrolling fashion. The user may navigate through the list of presented profiles by swiping up and down. One current profile 11 occupies most of the screen at a time, with a portion of the previous profile 12 showing at the top, and a portion of the next profile 13 showing at the bottom. Each profile may comprise a photo, video, or audio of a suggested user and one or more aspects of the suggested user's information. Using a touchscreen of terminal 10, the user may request that connecting server 30 provide more information about a profile by touching on picture 17 associated with that profile. Connecting server 30 may then communicate to the user more information about that profile by retrieving the information from the memory of the server.

In some embodiments, a user may express interest or no interest in a presented profile. Such expression may be accomplished through various methods. For example, each profile may also be associated with user interface controls comprising interest button 14 and no-interest button 15 (represented by an “X” icon). Touching interest button 14 indicates to connecting server 30 that the user is interested in communicating with the other user associated with the presented profile. Touching no-interest button 15 indicates that the user does not want to communicate with the presented user and may eliminate the profile from the display. Touching either button may cause the list of profiles to automatically scroll up, displaying the next profile in the list at the center of the display.

In some embodiments, each user has a point amount. A newly registered user may be awarded an initial point amount upon the first log-in. Thereafter, each user may be awarded more points for each day they log in or for other encouraged activities such as watching advertisements. In some embodiments, a user may express interest in a profile by a gesture such as touching interest button 14 to allocate points to that profile. Upon detecting the user's gesture, connecting server 30 stores in its database an indication that the user has allocated points to the profile, which may include other details such as how many points have been allocated. Touching interest button 14 may also add the profile to a list of profiles, e.g., bookmarks, associated with the user.

In some embodiments, each profile has a point threshold. Before a user may allocate points to a profile, the user's current point amount is compared to the point threshold of the profile. The result of this comparison may affect whether the user can allocate points to the profile. For example, after reading the point amount of a user, system 100 allows the user to allocate points to a profile if it detects that the user's point amount is equal to or larger than the point threshold of the profile. In the example depicted in FIG. 1B, point amount display 18 at the upper left corner of the screen shows that the user's point amount is 46 points, which is larger than the point threshold of 16 points which may be displayed on interest button 14. That means, in this scenario, the user may express interest in profile 11 by touching interest button 14 and allocate points to the profile. The appearance of interest button 14 may be used to signal to the user that the user may do so. For example, interest button 14 may be presented as a green button when that is the case. In other embodiments, other specified results of comparing the user's point amount and the point threshold of the profile, e.g., one exceeds the other by 10 points, may be required to allow the user to allocate points to the profile. Other embodiments may require two users to match in a double-blind opt-in fashion before allowing them to allocate points to each other.

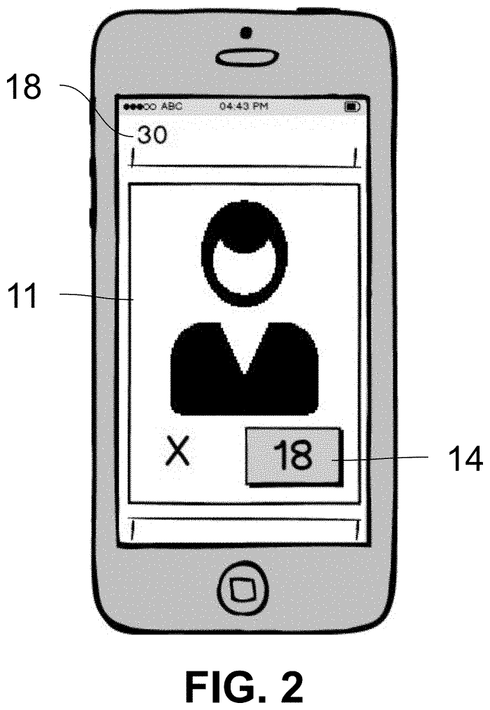

In some embodiments, after the allocation, the user's point amount may be changed in a certain way, e.g., reduced by the number of points allocated. For example, when a user may allocate points to a profile, touching interest button 14 may cause the user's point amount to be reduced by the same number of points in the point threshold of the profile, and that many points to be allocated. For example, FIG. 2 depicts the changed state of FIG. 1B, in one embodiment, after the user touches green interest button 14 to allocate points to profile 11. Point amount display 18 shows that the user's point amount decreases to 30 points from 46 points because the user has allocated 16 points to the profile, which was the point threshold of the profile at the time of allocation.

In some embodiments, after the allocation, the point threshold of the profile may be changed in a certain way, e.g., increased by 10 percent, rounded up. For example, the embodiment depicted in FIG. 2 shows that after the user touches green interest button 14, the point threshold of profile 11 increases 10%, rounded up, from 16 to 18 points.

In some embodiments, the appearance of interest button 14 may be used to signal to the user that the user is the one who is allocating the greatest number of points to the profile, i.e., who has caused the point threshold of the profile to increase to its current value. For example, FIG. 2 shows that green interest button 14 of FIG. 1B has been changed to a blue or darker button after it is touched.

In some embodiments, the user can keep allocating additional points to the profile by touching blue interest button 14 again. With each touch of blue interest button 14, the user's point amount may decrease by the number of points that is equal to the difference between the current point threshold of the profile and the total number of points that the user has allocated to the profile. The user may keep allocating additional points to the profile until the user does not have enough points in the user's point amount to do so. In some embodiments, with each touch of interest button 14, the point threshold of the profile may increase 10%.

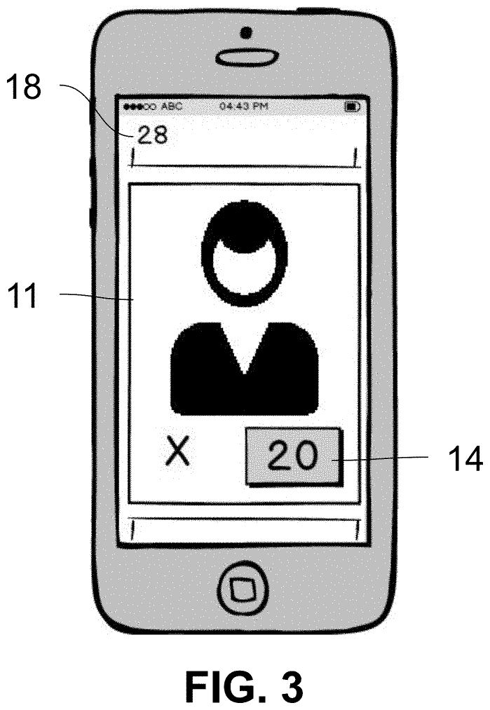

FIG. 3 shows, in one example, the state of FIG. 2 after system 100 detects a second touch gesture on interest button 14 indicating that the user allocates an additional 2 points to profile 11 to bring the total number of points that the user has allocated to the profile to 18, matching the point threshold of the profile. In response to such detection, connecting server 30 stores this additional point allocation in its memory. The user's point amount decreases by the additional 2 points to 28. The point threshold increases 10%, rounded up, to 20.

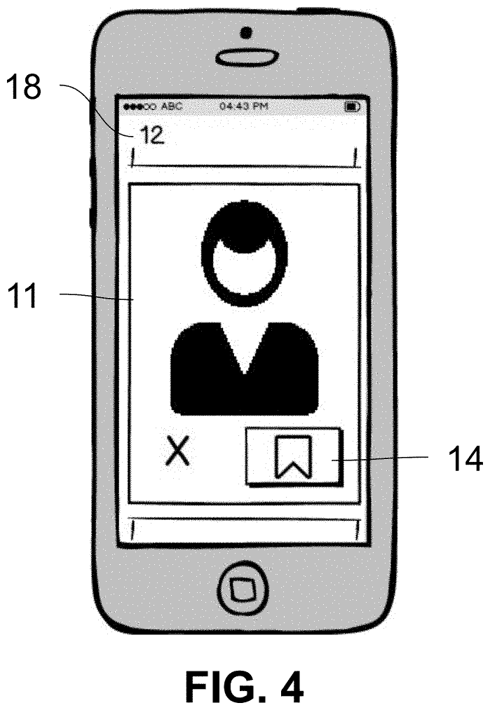

In some embodiments, when a third user allocates more points to the profile than the user has, the points that the user has allocated to the profile may be returned to the user's point amount. Interest button 14 may no longer be blue. It may become green if the user has enough points to allocate to the profile again or otherwise become a bookmark button as illustrated in FIG. 4.

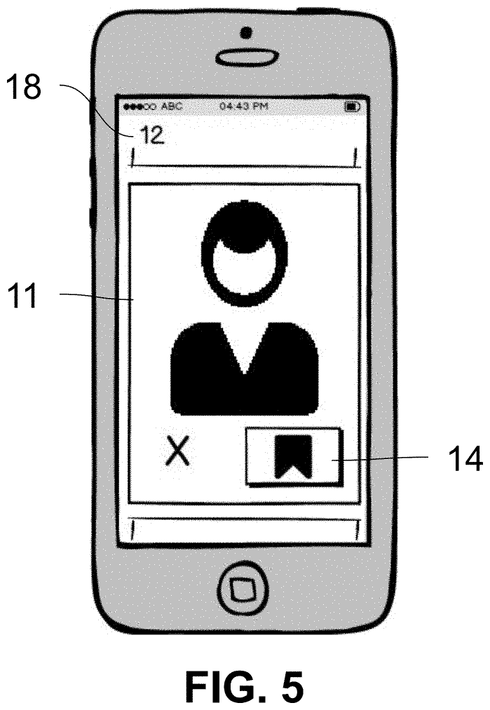

FIG. 4 shows, in one embodiment, the user interface of terminal 10 when the result of comparing the user's point amount to the point threshold of profile 11 shows that the user is not allowed to allocate points to the profile. For example, system 100 detects that the user's point amount is less than the point threshold of the profile. In some embodiments, the appearance of interest button 14 may be used to signal to the user that the user may not allocate points to the profile. For example, interest button 14 may be presented as a bookmark button when that is the case. The button may be a toggle button to allow the user to add (bookmark) or remove (un-bookmark) the profile to or from a list of profiles (e.g., list of bookmarked profiles). If the user has not bookmarked the profile, the bookmark button may contain a white bookmark icon. Detecting a gesture on the button causes the profile to be added to the list of profiles stored in the memory of connecting server 30 and may cause the bookmark icon to change to black as depicted in FIG. 5. Touching interest button 14 with a black bookmark icon causes the reverse: removing the profile from the list of profile and changing the bookmark icon to white.

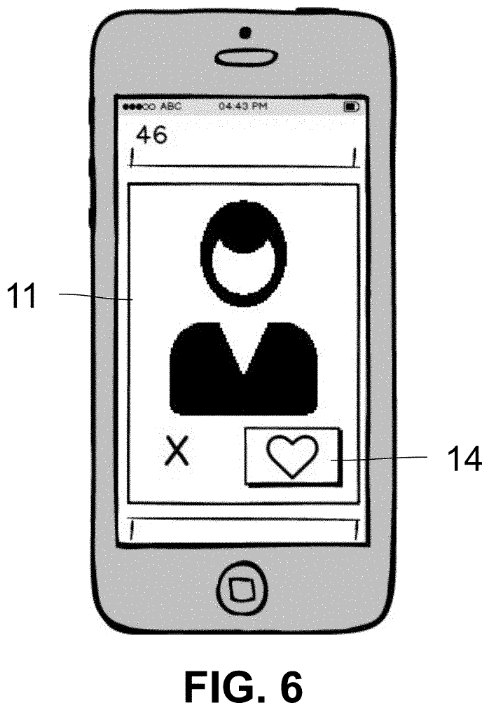

In some embodiments, as depicted in FIG. 6, when system 100 detects that a second user who is associated with profile 11 has allocated points to the logged-in user, interest button 14 may be changed to a heart button to allow the logged-in user to instantly create a connection with the second user. When system 100 detects a gesture on button 14, e.g. a touch, it creates and stores a connection between the logged-in user and the second user in the database and allows them to communicate with each other.

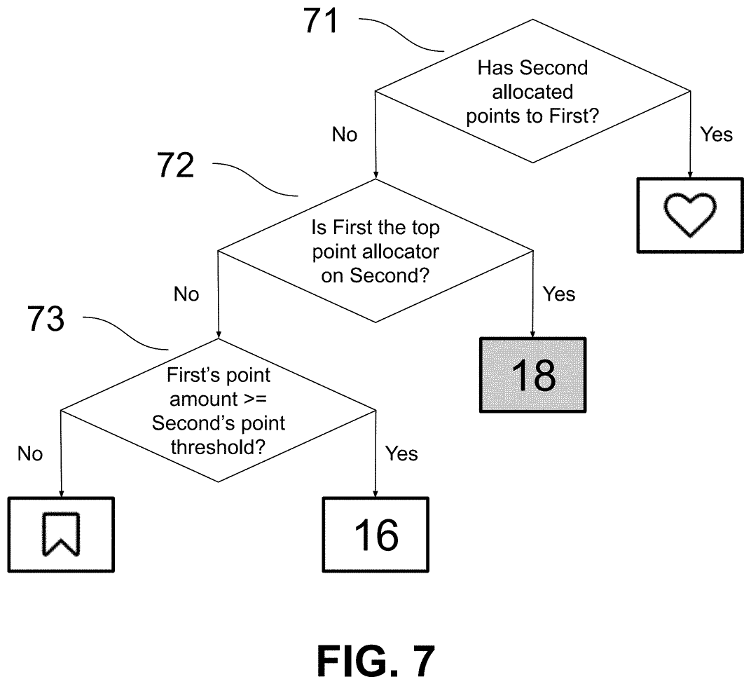

FIG. 7 is a flowchart depicting a method of displaying user interface control 14 of terminal 10 of FIGS. 1B-6 in connecting system 100 of FIG. 1A in accordance with an embodiment where a First user is viewing the profile of a Second user. At step 71, the system determines if Second has ever allocated points to First today. If yes, user interface control 14 may be presented as a heart button to allow First to touch to connect with Second instantly.

At step 72, if Second has not allocated any point to First today, the system determines if First is the user currently allocating the greatest number of points to Second. If yes, user interface control 14 may be presented as a blue or darker button to signal to First that he is currently the top point allocator on Second. First may allocate more points to Second by touching on the blue button again.

At step 73, if First is not the user currently allocating the greatest number of points to Second, the system determines if First's point amount is larger than or equal to Second's current point threshold. If yes, user interface control 14 may be presented as a green or lighter button to signal to First that he may touch to allocate points to Second. If no, user interface control 14 may be presented as a toggle bookmark button to allow First to add or remove Second's profile to or from a list of profiles.

Interface control 14, of which the appearance and functions may dynamically change based on users' various situation significantly simplifies the user interface and makes it easy to use.

In some embodiments, at a predetermined time, e.g. at the end of each day, the user who has allocated the greatest number of points to a profile associated with a target user automatically earns a connection to chat with that target user. Alternatively, the user's number of points allocated to the target user may function as a factor among various other factors, e.g., whether they match each other's explicit or implicit preferences for a partner, in determining whether a connection should be established between them. In this manner, the more points a user allocates to a target, which indicates how interested the user is in chatting with the target, the more likely they will be connected.

In some embodiments, a target user may request and see a list of profiles of all users who have allocated points to the target user regardless of whether a user is one who is allocating the highest number of points to the target compared to other users. Each such profile may have interest button 14 in the form of a heart button. The target user may choose to touch a heart button on any of those profiles to instantly connect with the user behind that profile. To help the target user focus, system 100 may allow the target user to touch only one heart button a day.

In some embodiments, after a new connection is created as discussed above, either automatically at a predetermined time or by the target user touching a heart button, the point threshold on the target user's profile may reset, e.g., to 1 point. Each user's profile may be removed from the other user's views or bookmarks. The list of profiles of users who have allocated points to a target user may be reset to empty. In some embodiments, after a connection is created, a portion of the points a user allocated to a target user may be credited to the target user's point amount. In this manner, the more desirable a user is to other users, the more points the user accumulates over time, and the more points the user has to allocate to others. In some embodiments, to encourage communications, the credit may be given only if the target sends a message. A portion of the points allocated may be returned to the user if the target does not send a message after a predetermined period. In some embodiments, touching the heart button on a profile associated with a user that is not currently one who has allocated the greatest number of points to the target user may cause those points to be returned to that user's point amount and prevent that user from winning a connection with the target user automatically at the predetermined time.

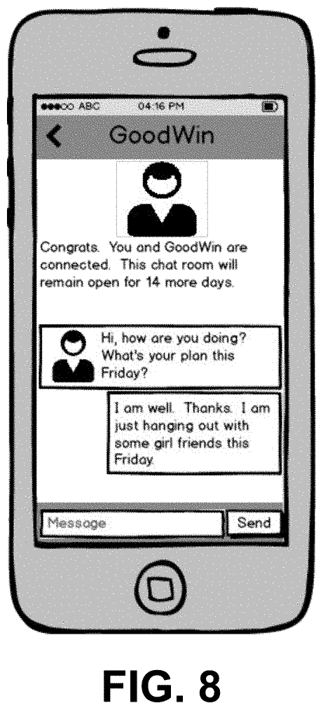

In some embodiments, after a connection is created, connecting server 30 may present an option to the two users who have been connected to engage in a communication session (e.g., a chat, an SMS message, an e-mail, a telephone call, a voice communication session, a video communication session). FIG. 8 illustrates an example communication interface between two connected users in the connecting system. A user may have the option on this interface to delete the connection and block the other user if the user no longer wishes to continue communicating with the connection. To help encourage users to quickly move communication offline, a connection may automatically expire after a preset period.

Some embodiments of the invention are related to the use of a computer system, a server, or a mobile device, for implementing the techniques described herein. According to one embodiment of the invention, those techniques are performed by a computer system in response to a processor executing one or more sequences of one or more instructions contained in a main memory. Such instructions may be read into the main memory from another machine-readable medium, such as a storage device. Execution of the sequences of instructions contained in the main memory causes the processor to perform the process steps described herein. In alternative embodiments, hard-wired circuitry may be used in place of or in combination with software instructions to implement the invention.

The term non-transitory computer-readable medium as used herein refers to any medium that participates in providing data that causes a machine to operate in a specific fashion. In an embodiment implemented using the computer system, various machine-readable media are involved, for example, in providing instructions to the processor for execution. Such a medium may take many forms, including but not limited to storage media and transmission media. Storage media includes both non-volatile media and volatile media. Non-volatile media includes, for example, optical or magnetic disks, such as a storage device. Volatile media includes dynamic memory, such as a main memory. Transmission media includes coaxial cables, copper wire, and fiber optics, including the wires that comprise a bus. Transmission media may also take the form of acoustic or light waves, such as those generated during radio wave and infra-red data communications. All such media must be tangible to enable the instructions carried by the media to be detected by a physical mechanism that reads the instructions into a machine.

Modifications, additions, or omissions may be made to the methods described herein without departing from the scope of the disclosure. For example, the steps may be combined, modified, or deleted where appropriate, and additional steps may be added. Additionally, the steps may be performed in any suitable order without departing from the scope of the present disclosure. Also, it is understood that the computer implemented methods described herein can be embodied in computer readable media as instructions that are executable by a computer (e.g., processor of a computer) to cause the computer and/or other devices to perform the steps of the methods.

Although several embodiments have been illustrated and described in detail, it will be recognized that substitutions and alterations are possible without departing from the spirit and scope of the appended claims.

What is claimed is:

1. A method of displaying a user interface, comprising:
presenting a graphical representation of an item of information associated with a profile, the profile having a point threshold;
reading a point amount of a user;
comparing the point amount of the user with the point threshold of the profile;
presenting a user interface control associated with the profile;
detecting that a result of said comparing allows the user to allocate points to the profile;
detecting a first gesture associated with the user interface control, the first gesture corresponding to an indication that the user allocates points to the profile; and
storing the point allocation indication in response to detecting the first gesture.

2. The method of claim 1 wherein said presenting a user interface control comprising presenting the interface control according to the comparison.

3. The method of claim 1, further comprising:
changing the user interface control in response to detecting the first gesture.

4. The method of claim 1, further comprising:
changing the point threshold in response to the first gesture.

5. The method of claim 1, further comprising:
changing the point amount in response to the first gesture.

6. The method of claim 1, further comprising:
detecting a second gesture associated with the user interface control, the second gesture corresponding to an indication that the user allocates additional points to the profile; and
storing the additional point allocation indication in response to detecting the second gesture.

7. The method of claim 6, further comprising:
changing the point threshold in response to the second gesture.

8. The method of claim 6, further comprising:
changing the point amount in response to the second gesture.

9. A method of displaying a user interface, comprising:
presenting a graphical representation of an item of information associated with a profile, the profile having a point threshold;
reading a point amount of a user;
comparing the point amount of the user with the point threshold of the profile;
presenting a user interface control associated with the profile;
detecting that a result of said comparing does not allow the user to allocate points to the profile;
detecting a gesture associated with the user interface control, the gesture corresponding to the user adding or removing the profile to or from a list of profiles; and
updating said list of profiles in response to detecting the gesture.

10. The method of claim 9 wherein said presenting a user interface control comprising changing the interface control according to the comparison.

11. The method of claim 9, further comprising:
changing the user interface control in response to detecting the gesture.

12. A method of displaying a user interface, comprising:
presenting a graphical representation of an item of information associated with a profile;
presenting a user interface control associated with the profile to allow a first user, having a first point amount, to allocate points to the profile;
detecting that the profile is associated with a second user, having a second point amount, who has allocated points to the first user;
detecting a gesture associated with the user interface control, the gesture corresponding to the first user creating a connection to the second user; and
storing the connection between the first user and the second user.

13. The method of claim 12, further comprising:
changing the user interface control in response to detecting that the second user has allocated points to the first user.
